(19) United States
(12) Patent Application Publication
(10) Pub. No.: US 2026/0285707 A1
(43) Pub. Date: Sep. 24, 2026

(54) WATER FILTRATION ASSEMBLY AND METHOD FOR ASSEMBLY

(71) Applicant: Haier US Appliance Solutions, Inc., Wilmington, DE (US)

(72) Inventors: Thomas Earl McKeehan, JR., Crestwood, KY (US); Jeffrey Michael Colyer, Louisville, KY (US)

(21) Appl. No.: 19/084,879

(22) Filed: Mar. 20, 2025

(51) Int. Cl. C02F 1/00; C02F 1/48

(52) U.S. Cl. CPC C02F 1/003; C02F 1/484; C02F 2201/007; C02F 2201/3222; C02F 2209/00; C02F 2307/12

(57) ABSTRACT

An aspect of the present disclosure is directed to a water filtration assembly for an appliance including a first mating interface at which a housing end cap couples to a housing. A plenum is formed between the housing end cap and a media block end cap at which a filtration media block is received and positioned in the housing. The media block end cap and the housing together include an anti-rotation interface configured to inhibit rotation of the media block end cap relative to the housing. An electrically-driven module is positioned in operable arrangement with fluid received at a media block internal volume downstream of a porous structure of the filtration media block and a first flow passage between an inner surface of the housing and an outer surface of the filtration media block.

### FIELD OF THE INVENTION

The present subject matter relates generally to water filtration assemblies, and more particularly to water filtration assemblies having enhanced contaminant reduction performance.

### BACKGROUND OF THE INVENTION

Fresh water is a limited resource on the earth. Water shortage and contamination are among the top current issues in public health. With an increase in drinking water contaminant levels and the emergence of new contaminants, improvements in chemical and microbiological reduction performance of end point water treatment systems are desired to ensure consumer protection from potentially harmful exposure.

Water treatment using adsorptive media has been in practice since ancient times. Although modern Activated Carbon-based (AC) technologies allow the reduction of multiple health-related contaminants, further significant improvement of contaminant reduction performance is challenging. In most cases, an improvement of contaminant reduction performance requires an increase of physical dimensions of the product (a limiting factor for many residential applications, such as residential appliances), and/or a reduction of effective pore size (pore size reduction demands higher feed pressures or lowers flow rates which are also limiting factors for most residential applications). For most AC-based systems, the microbiological reduction is limited to relatively large protozoa, and most of these systems provide no protection from harmful bacteria and viruses.

Water treatment using germicidal ultraviolet (UV) radiation has also been practiced for several decades. Although UV treatment can provide significant levels of microbiological reduction, it has several disadvantages. For example, UV treatment requires direct line of sight, and to be effective, the treated water must be optically clear and contain no particulates. UV provides some levels of reduction for additional contaminants, but these levels are inferior to the reduction level granted by many alternative water treatment methods.

Systems combining AC modules and ultraviolet-C (UVC) modules exist in the market as well. Although these systems combine the benefits, and mitigate the disadvantages, of both technologies used separately, they are mechanically complex, have a large footprint, and often require multiple replaceable consumables when combined together. As such, the excessive complexity and space limitations restrict an integration of these combined systems into most household appliances where the space is limited. Moreover, systems with multiple consumable elements impose a greater burden on the end consumer and generate undesired environmental waste.

Additionally, cost is a critical factor, which can prohibit application of combined AC-UVC modules into residential applications. Methods for fabrication and assembly of combined AC-UVC systems are desired for improving manufacturability and reducing cost.

Accordingly, there is a continuous need for a water filtration assembly having enhanced contaminant reduction performance to address the aforementioned issues.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a water filtration assembly for an appliance. The water filtration assembly includes a housing having an inner surface adjacent to a housing internal volume, a fluid inlet opening, a fluid outlet opening, and a distal end. A filtration media block is positioned at the housing internal volume. A first flow passage extends in fluid communication from the fluid inlet opening. The first flow passage is at least partially formed between the inner surface of the housing and an outer surface of the filtration media block. The filtration media block includes a media block internal volume extending from a media block distal end opening. The filtration media block includes a porous structure permitting fluid flow from the first flow passage to the media block internal volume. A media block end cap is positioned at the media block distal end opening to receive the filtration media block. The media block end cap and the housing together include an anti-rotation interface configured to inhibit rotation of the media block end cap relative to the housing. A housing end cap is receivable at the distal end of the housing. A plenum is formed between the housing end cap and the media block end cap. The water filtration assembly includes a first mating interface at which the housing end cap couples to the housing. An electrically-driven module is positioned in operable arrangement with fluid received at the media block internal volume.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a front view of an embodiment of an appliance according to the present disclosure;

FIG. 2 illustrates a perspective view of the appliance shown in FIG. 1;

FIG. 3 illustrates a front view of the refrigerator appliance shown in FIG. 1 with doors in an open position;

FIG. 4 illustrates a simplified side view of an embodiment of a water filtration assembly secured within an appliance according to the present disclosure;

FIG. 5 illustrates a cross sectional side view of an embodiment of a water filtration assembly in accordance with aspects of the present disclosure;

FIG. 6 illustrates a detailed cross sectional side view of the embodiment of the water filtration assembly of FIG. 5 in accordance with aspects of the present disclosure;

FIG. 7 illustrates a perspective view of an embodiment of the media block end cap of the water filtration assembly of FIG. 5 in accordance with aspects of the present disclosure;

FIG. 8 illustrates a cross sectional side view of an embodiment of a water filtration assembly in accordance with aspects of the present disclosure;

FIG. 9 illustrates a detailed cross sectional side view of the embodiment of the water filtration assembly of FIG. 8 in accordance with aspects of the present disclosure; and

FIG. 10 illustrates a perspective view of an embodiment of the media block end cap of the water filtration assembly of FIG. 8 in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value, or values within ten percent greater or less than a full scale of a specified range. In this regard, for example, when used in the context of a distance, a distance of approximately 100 units includes up to 110 units. In another regard, for example, a distance between approximately 25 units and approximately 100 units includes a range from 18.5 units to 107.5 units.

Embodiments of a water filtration assembly addressing one or more of the aforementioned issues are provided. Embodiments herein include water filtration assemblies for an appliance, such as a refrigerator appliance, an icemaker appliance, a dishwasher appliance, a water purifier appliance, a beverage system appliance, or washing machine appliance, or other water-utilizing appliance or water-dispensing appliance. Aspects of the subject matter include methods for fabrication of a water filtration assembly having structures addressing one or more of the aforementioned issues.

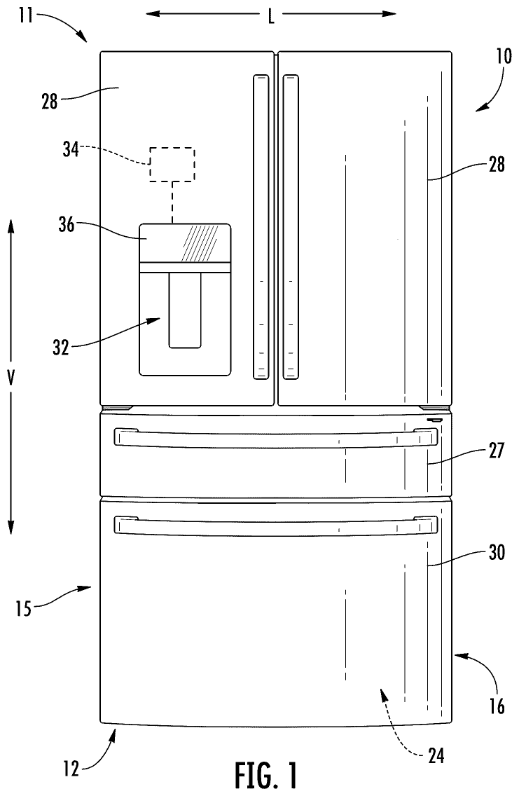

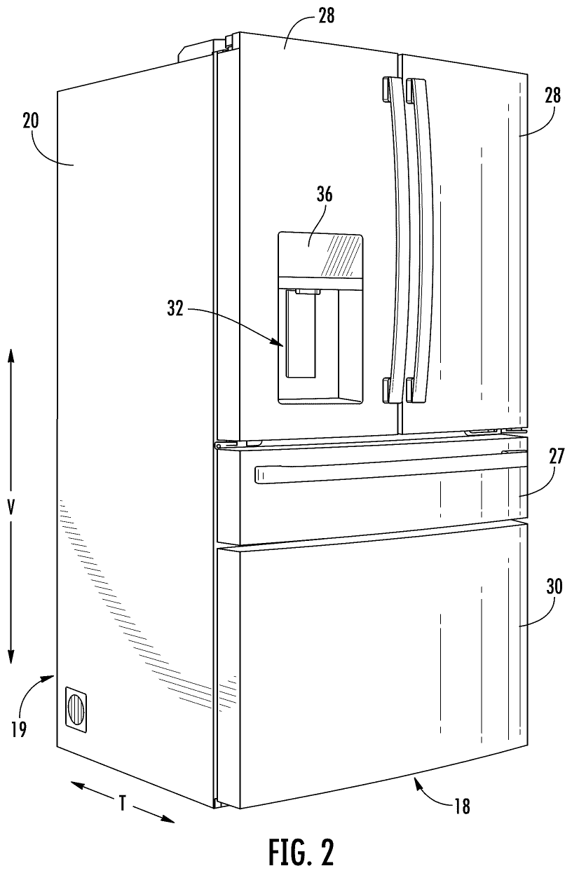

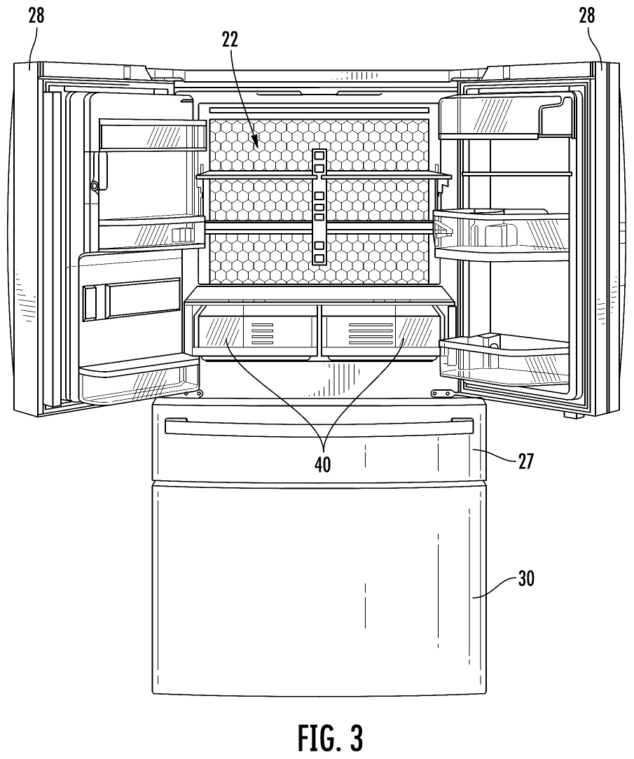

Referring now to the drawings, FIG. 1 illustrates a front view of an embodiment of a refrigerator appliance 10 according to the present disclosure. FIG. 2 illustrates a perspective view of the refrigerator appliance 10. FIG. 3 illustrates a front view of the refrigerator appliance 10 with refrigerator doors 28 in an open position. FIG. 1, in particular, illustrates the refrigerator appliance 10 extending between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary chamber.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

The controller 34 may include a memory and one or more microprocessors, CPUs or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

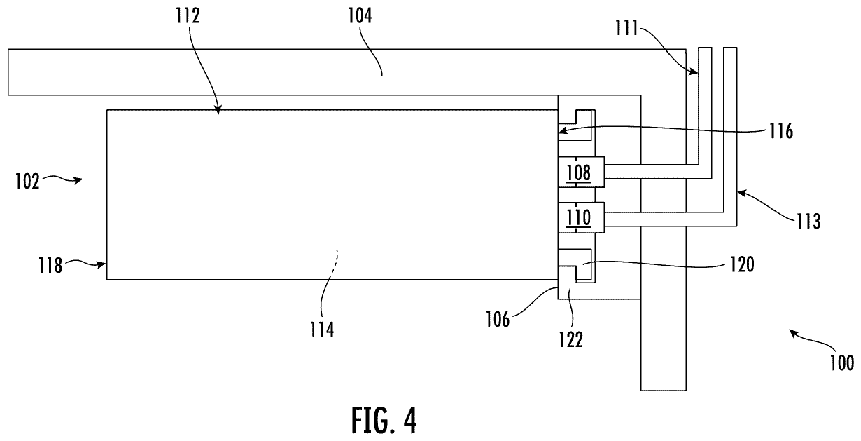

Referring now to FIG. 4, a simplified side view of an embodiment of an appliance 100 having a water filtration assembly 102 according to the present disclosure is illustrated. In particular, as shown, the appliance 100 includes at least one wall 104 having a manifold 106 secured thereto. Furthermore, as shown, the appliance 100 generally includes a water source (not shown) that provides water to and from the water filtration assembly 102, e.g., through the manifold 106 via a water inlet 108 and a water outlet 110. In addition, as shown, the appliance 100 may include a supply conduit 111 fluidly coupled to the water inlet 108 to provide pre-treated water to the water filtration assembly 102, and a return conduit 113 fluidly coupled to the water outlet 110 to flow treated water from the water filtration assembly 102, such as further described herein.

Referring to FIG. 4, the water filtration assembly 102 includes a filtration housing 112 and a filtration media block 114. The filtration media block 114 is positioned in serial fluid arrangement between the water inlet 108 and the water outlet 110. In the illustrated embodiment, the filtration housing 112 includes a first end 116 for securing the water filtration assembly 102 to the manifold 106 and a second end 118 for receiving at least a housing end cap including electrical or electronic components of the water filtration assembly 102. In various embodiments, the first end 116 of the filtration housing 112 may include one or more interlocking features 120 configured to secure the water filtration assembly 102 to corresponding interlocking features 122 of the manifold 106 positioned on the wall 104 of the appliance 100. In further embodiments, the first end 116 of the filtration housing 112 may be secured to the manifold 106 using any suitable means.

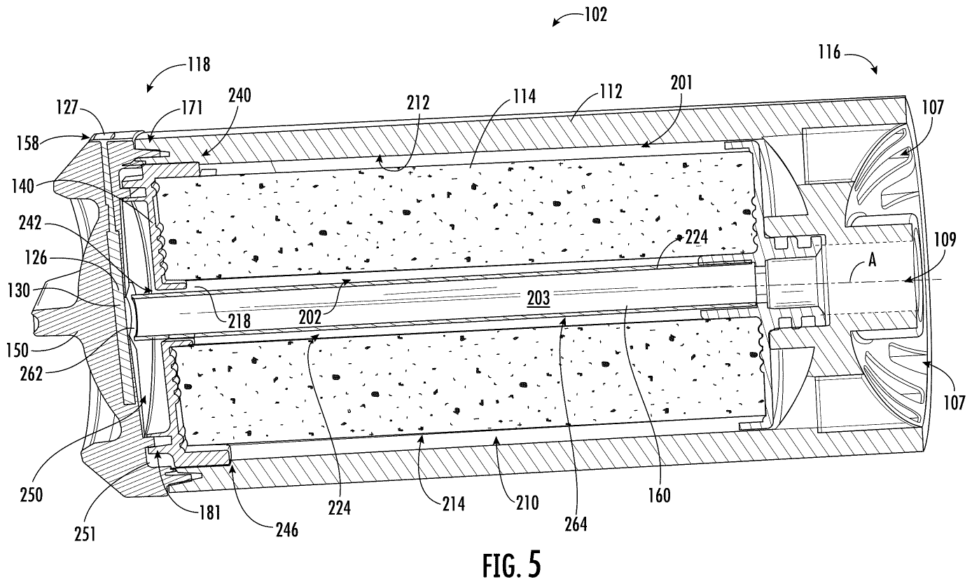

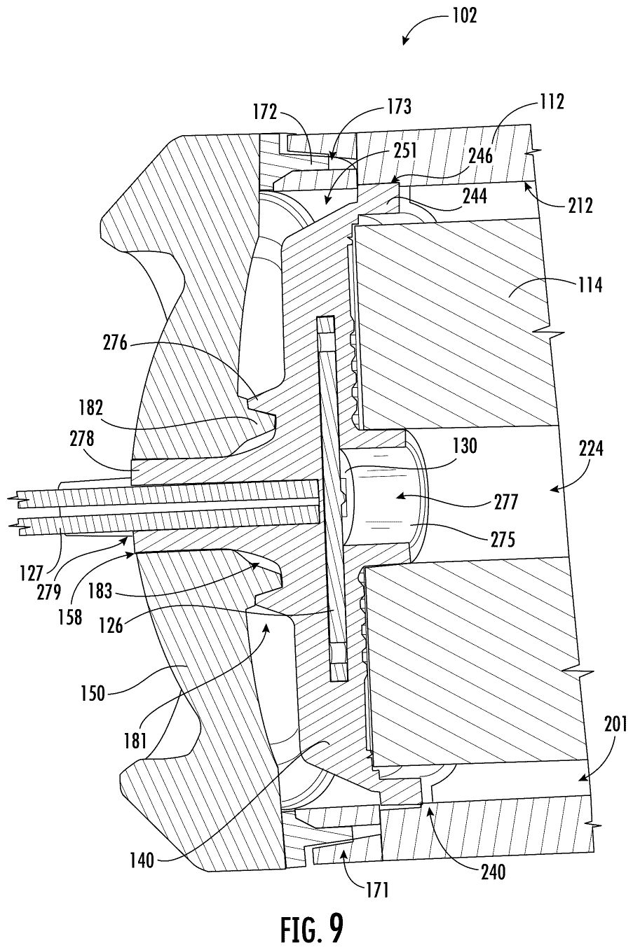

Referring now to FIGS. 5-10, embodiments of the water filtration assembly 102 include a filtration housing 112 having an inner surface 212 adjacent to a housing internal volume 210, a fluid inlet opening 107, a fluid outlet opening 109, and a second or distal end 118, such as may be distal to the first end 116. A filtration media block 114 is positioned within the housing internal volume 210. A first flow passage 201 extends in fluid communication from the fluid inlet opening 107. The first flow passage 201 is at least partially formed between the inner surface 212 of the housing 112 and an outer surface 214 of the filtration media block 114. The filtration media block 114 includes a media block internal volume 224 extending from a media block distal end opening 218. The filtration media block 114 includes a porous structure permitting fluid flow from the first flow passage 201 to the media block internal volume 224.

In various embodiments, a media block end cap 140 is positioned at the media block distal end opening 218 to receive the filtration media block 114. A housing end cap 150 is receivable at the distal end 118 of the housing 112. A plenum 251 is formed between the housing end cap 150 and the media block end cap 140. In various embodiments, the media block end cap 140 is separately receivable at the filtration media block 114 from the housing end cap 150 at the housing 112. For instance, the media block end cap 140 is a separate component from the housing end cap 150, and the separate components are received at the housing 112.

Embodiments of the filtration media block 114 described herein may be constructed of any suitable material, such as activated carbon (AC). In such embodiments, the adsorptive, catalytic, and structural properties of AC make it effective at capturing contaminants including particulates, volatile organic compounds (VOCs), metals, pharmaceuticals, pharmaceutical break-down products, per-and polyfluoroalkyl substances (PFASs), disinfectants, disinfectant by-products, and other contaminants. In another embodiment, the filtration media block 114 may be constructed of a zeolite, a non-woven material, a textile, an immobilized granulated media, an ion exchange resin, a membrane, a hollow fiber, and/or a composite of natural or synthetic materials.

In some embodiments, the filtration media block 114 includes a polymer hydrogel including a water-permeable structure cross-linked hydrophilic polymer network. The polymer hydrogel filtration media block 114 may include a membrane at which a plurality of nanoparticles may be included or embedded. The nanoparticles may be configured to target desired contaminants, such as to enhance filtration of certain contaminants more than others. Polymer hydrogels may include natural polymers, synthetic polymers, or combinations thereof, including, but not limited to, hyaluronic acid, chitosan, heparin, alginate, gelatin, fibrin, polyvinyl alcohol, polyethylene glycol, sodium polyacrylate, acrylate polymers, polyethylene glycol (PEG), polyacrylate, or polyvinylpyrrolidone (PVP), or combinations thereof.

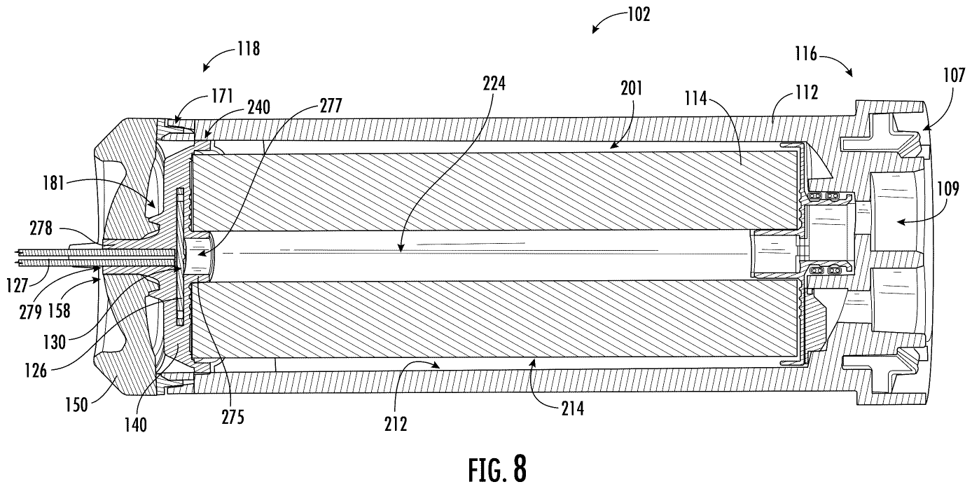

An electrically-driven module 126 includes an electric wire lead 127 extending through the housing end cap 150. A sensor 130 is positioned in operable arrangement with fluid received at or downstream of the media block internal volume 224. In some embodiments, such as depicted in FIGS, 5-6, the sensor 130 is positioned at the housing end cap 150. In still some embodiments, such as depicted in FIGS. 8-10, the sensor 130 is positioned at the media block end cap 140.

Referring to FIGS. 5-10, in various embodiments, the media block end cap 140 and the housing 112 together include an anti-rotation interface 240 configured to inhibit rotation of the media block end cap 140 relative to the housing 112. In some embodiments, the anti-rotation interface 240 includes a key interface including a key 244 and slot 246 at which the key 244 is receivable. In an embodiment, the media block end cap 140 includes the key 244, and the housing 112 includes the slot 246 at which the key 244 is received. In other embodiments, the housing 112 includes the key 244 and the media block end cap 140 include the slot 246. The key 244 may include a castellation, a crenelation, a tooth, a raised wall, or other raised surface extendable into the slot 246. The slot 246 may include an indentation, curve, or other geometry, such as at the housing 112, into which the key 244 is receivable. In various embodiments, the anti-rotation interface 240 at the housing 112 is positioned at the inner surface 212 of housing 112. As such, the media block end cap 140 couples to the housing 112 at the inner surface 212 of the housing 112.

In various embodiments, the key 244 and slot 246 extend substantially co-directional to an axis (e.g., centerline axis A) along which the housing 112 or the housing end cap 150 may be rotated, or extend substantially along a direction of rotation thereof, in a friction joining process, such as a spin welding process. As such, the key 244 extending into the slot 246 may inhibit rotation of the media block end cap 140 relative to the housing 112.

Additionally, coupling or inserting the media block end cap 140 to the housing 112 may be performed or limited to articulation substantially along the axis (e.g., axis A) along which the housing 112 or the housing end cap 150 may be rotated in the friction joining process. In some embodiments, the key interface may include a fit, such as a press fit, interference fit, or other interaction between the key 244 and slot 246, to limit movement of the media block end cap 140 relative to the housing 112 along the axis along which the media block end cap 140 is inserted into the housing 112 (e.g., centerline axis A).

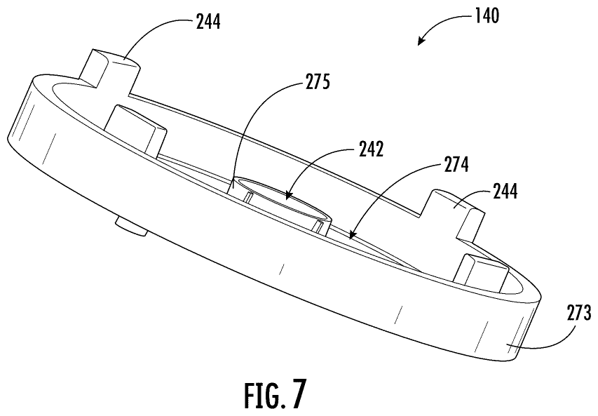

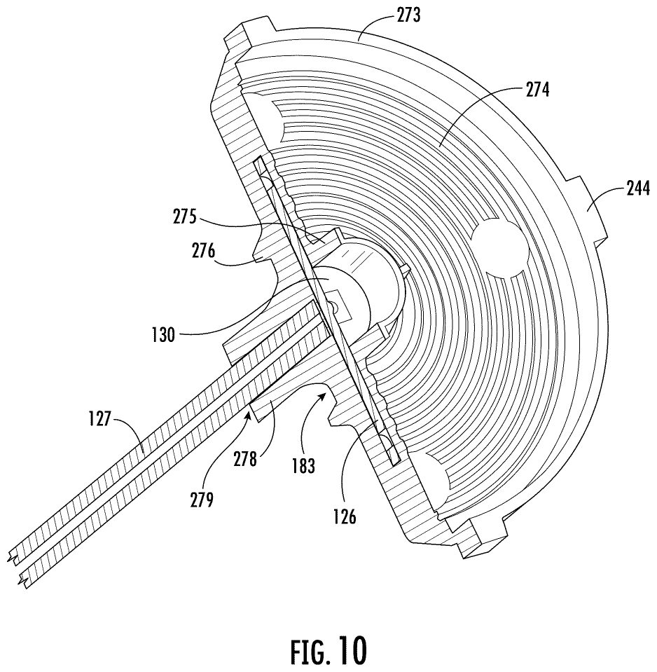

Referring briefly to FIG. 7 and FIG. 10, in various embodiments, the media block end cap 140 includes a base wall 274 at which the filtration media block 114 is receivable. An outer perimeter wall 273 may extend from the base wall 274, such as substantially co-directional to axis A. For instance, the outer perimeter wall 273 extends substantially co-directional to the axis A from the base wall 274 and toward the first end 116 of the water filtration assembly 102. Walls 273, 274 may extend substantially radially from axis A. In some embodiments, such as further described herein, a key 244 extends from outer perimeter wall 273 substantially co-directional to axis A. In still various embodiments, a sidewall 275 extends from the base wall 274, such as forming a wall extending around an end cap opening 242 and forming a passage, such as further described herein. For instance, the sidewall 275 may form a cylindrical barrier extending into the media block internal volume 224. As described in various embodiments herein, the sidewall 275 may provide a passage 277 at which the sensor 130 is positioned or a conduit 160 extends through the media block end cap 140.

Referring to FIGS. 5-10, in various embodiments, housing end cap 150 includes a lead egress opening 158 through which the electric wire lead 127 is permitted to extend to the sensor 130. In some embodiments, the lead egress opening 158 includes a passage extending through the housing end cap 150. Referring to FIG. 7, the electrically-driven module 126 including the sensor 130 is positioned at the housing end cap 150, and the electric wire lead 127 extends from the sensor 130 through the housing end cap 150 through the lead egress opening 158 to route to an exterior of the housing end cap 150.

Referring to FIGS, 9-10, in still some embodiments, the housing end cap 150 and the media block end cap 140 each include an opening through which the electric wire lead 127 is permitted to extend to an exterior of the housing end cap 150. The lead egress opening 158 at the housing end cap 150 may form a passage permitting the electric wire lead 127 to extend therethrough. In some embodiments, the electrically-driven module 126 including the sensor 130 is positioned at the media block end cap 140, such as depicted in FIGS. 8-10. The media block end cap 140 may include a neck 278 configured to extend into the housing end cap 140 at the lead egress opening 158. The neck 278 include a lead egress opening 279 through which the electric wire lead 127 extends from the media block end cap 140 and through the housing end cap 150 to an exterior of the water filtration assembly 102.

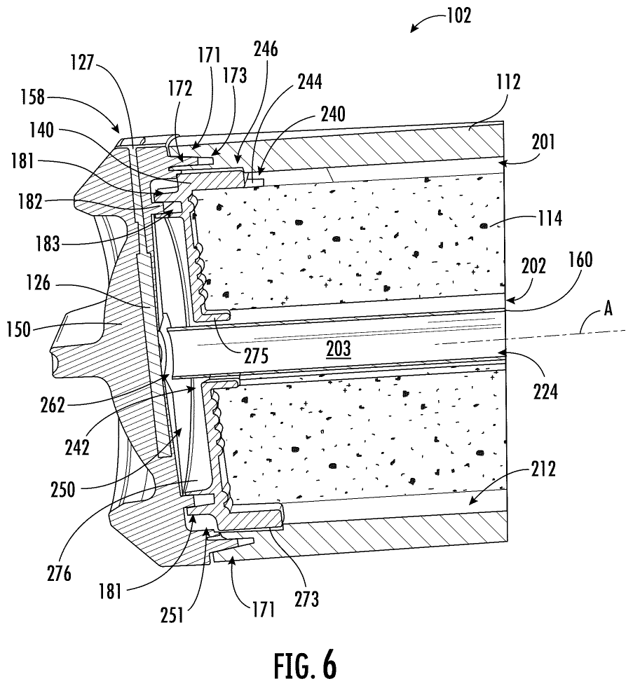

In some embodiments, the lead egress openings 158, 279 extend substantially along the centerline axis A, such as depicted in FIGS. 8-10. For instance, the media block end cap 140 and the housing end cap 150 each include the lead egress opening 158, 279 positioned through the centerline axis A mutual to the media block end cap 140, the housing end cap 150, and the housing 112. In still some embodiments, one or more lead egress openings 158, 279 may extend radially outward or off-center from the centerline axis A (e.g., depicted in FIGS. 5-6).

As described herein, embodiments of the water filtration assembly 102 and methods for fabrication depicted and described herein may facilitate or permit routing and egressing of electric wire leads 127 such as described herein, and furthermore, while sealing electrically-driven modules 126 and fluids while providing desired interaction between sensor signals and water within the water filtration assembly 102.

Referring to FIGS. 5-6 and FIGS. 8-9, in various embodiments, the water filtration assembly 102 includes a first mating interface 171 at which the housing end cap 150 couples to the housing 112. The plenum 251 is formed between the housing end cap 150 and the media block end cap 140. The first mating interface 171 may include a first wall 172 and a first slot 173 at which the first wall 172 is received. In an embodiment, the housing end cap 150 includes the first wall 172, and the housing 112 includes the first slot 173 at which the first wall 172 is received. In other embodiments, the housing 112 includes the first wall 172 and the housing end cap 150 include the first slot 173. The first wall 172 may form a raised wall extending substantially or fully circumferentially (e.g., relative to centerline axis A), and the first slot 173 may form a groove, indentation, or cavity at which the first wall 172 is receivable.

In a method for fabrication of the water filtration assembly 102, housing 112 and housing end cap 150 are joined together at the first mating interface 171 using a friction joining process, such as a spin welding process. One of the housing 112 or housing end cap 150 may be fixed or stationary as the other of the housing 112 and housing end cap 150 is rotated and pressed (e.g., along centerline axis A) together. Heat and friction at the first mating interface 171 bond the first wall 172 at the housing end cap 150 or housing 112 to the other of the housing 112 or housing end cap 150 at the first slot 173. As such, the separate housing 112 and housing end cap 150 components are joined at the first mating interface 171, such as may provide a fluidly sealed interior volume.

In various embodiments, the water filtration assembly 102 is configured to receive a flow of pre-treated water from the manifold 106 through water inlet 108 (FIG. 4) and into housing 112 through fluid inlet opening 107 and entering the first flow passage 201. The first flow passage 201 generally extends upstream from the filtration media block 114. Water is permitted to flow from the first flow passage 201, such as from between the inner surface 212 of the housing 112 and the filtration media block 114, through the porous structure of the filtration media block 114, such as may remove sediment and undesired matter from the water before flowing to the media block internal volume 224. As further described herein, sensor 130 is configured to operably communicate with water received from the filtration media block 114, such as to purify, sterilize, irradiate, or sense a physical or flow property of the water.

Embodiments of the water filtration assembly 102 including the key interface may inhibit rotation or movement of the media block end cap 140 relative to the housing 112 during a friction joining process, such as a spin weld process along axis A. Affixing the media block end cap 140 relative to the housing 112 may further remove movement of the media block end cap 140 and housing 112 relative to seals, sealants, or adhesives that may be positioned between housing 112 and the media block end cap 140, such as may mitigate damage to the seal and promote sealing and inhibit fluid flow between the housing 112 and the media block end cap 140 (e.g., along the inner surface 212). As such, pre-treated water at the first flow passage 201 is fluidly segregated from filtered water entering one or more plenums 250, 251 between the housing end cap 150 and the media block end cap 140. Additionally, pre-treated water at the first flow passage 201 may be fluidly segregated from water treated, sterilized, irradiated, or otherwise interacted with the electrically-driven module 126 in operably communication with water received from the porous structure (e.g., at the media block internal volume 224).

Referring to FIGS. 5-6 and FIGS. 8-9, in various embodiments, the water filtration assembly 102 includes a second mating interface 181 at which the housing end cap 150 couples to the media block end cap 140. In some embodiments, such as depicted in FIGS. 5-6, plenum 250 is formed between the housing end cap 150 and the media block end cap 140, and radially inward of the second mating interface 181. In still various embodiments, plenum 251 is formed radially between the first mating interface 171 and the second mating interface 181. In various embodiments, the second mating interface 181 is positioned radially outward of the sensor 130. The second mating interface 181 may include a second wall 182 and a second slot 183 at which the second wall 182 is received. In an embodiment, the housing end cap 150 includes the second wall 182, and the media block end cap 140 includes the second slot 183 at which the second wall 182 is received. In other embodiments, the media block end cap 140 includes the second wall 182 and the housing end cap 150 includes the second slot 183. The second wall 182 may form a raised wall extending substantially or fully circumferentially (e.g., relative to centerline axis A), and the second slot 183 may form a groove, indentation, or cavity at which the second wall 182 is receivable.

In some embodiments, depicted in detail at FIG. 6 and FIGS. 9-10, the media block end cap 140 includes a second perimeter wall 276 extending from the base wall 274, such as substantially co-directional to axis A. For instance, the second perimeter wall 276 extends substantially co-directional to the axis A from the base wall 274 and toward the second end 118 of the water filtration assembly 102, such as opposite along the direction of axis A from the first or outer perimeter wall 273. The second perimeter wall 276 and second wall 182 may together form a tongue and key, key and slot, or male/female interface at which a member is received at a slot.

As such, referring to FIGS. 5-7, the second mating interface 181 provides a seal interface sealing the plenum 250 formed between the housing end cap 150 and the media block end cap 140, and an end cap opening 242 provides fluid communication between the plenum 250 and the media block internal volume 224 such as described herein. Furthermore, the second mating interface 181 may provide a sealed interface between the media block end cap 140 and the housing end cap 150, such as may remove a need for applying a seal body, adhesive, or sealant to fluidly seal the plenum 250 from pre-treated fluid as described herein. As such, the second mating interface 181 may facilitate sealing and mitigate or eliminate a potential for improper or incomplete application of adhesive or sealant, damage to a seal body, or insufficient sealing contact of a sealant or seal body between sealing surfaces.

In a method for fabrication of the water filtration assembly 102, the first wall 172 is positioned into the first slot 173 such as provided regarding the housing 112 and housing end cap 150. Additionally, the second wall 182 is positioned into the slot 183 such as provided regarding the housing end cap 150 and the media block end cap 140. A friction joining process, such as a spin welding process, is performed such as may substantially simultaneously bond the housing 112 to the housing end cap 150 at the first mating interface 171 and the housing end cap 150 to the media block end cap 140 at the second mating interface 181 (e.g., a double spin-weld process). As such, the separate housing 112 and housing end cap 150 components are joined at the first mating interface 171, and the separate media block end cap 140 and housing end cap 150 are joined at the second mating interface 181, such as may provide a fluidly sealed interior volume including the plenum 250 and the housing internal volume 210.

In an embodiment, the housing 112 including the media block end cap 140 are fixed stationarily. The media block end cap 140 is affixed to the housing 112 at the key interface such that there is no relative rotation, or substantially no relative rotation, between the media block end cap 140 and the housing 112, such as may form a housing 112 and media block end cap 140 subassembly. The subassembly is fixed stationarily relative to the housing end cap 150 rotating in a friction joining process, such as a spin weld process, to affix the housing end cap 150 to the housing 112, or furthermore, affix the housing end cap 150 to the media block end cap 140 (e.g., a double-spin weld process).

In still various embodiments, the housing end cap 150 including the electrically-driven module 126 is fixed stationarily. The media block end cap 140 is affixed to the housing 112 at the key interface such that there is no relative rotation, or substantially no relative rotation, between the media block end cap 140 and the housing 112, such as may form a housing 112 and media block end cap 140 subassembly. The subassembly is rotated relative to the housing end cap 150 in a friction joining process, such as a spin weld process, to affix the housing end cap 150 to the housing 112, or furthermore, affix the housing end cap 150 to the media block end cap 140. In various embodiments, electrical lead wires 127 may be permitted to remain stationary, such as may mitigate damage related to rotation or rotational forces. Embodiments such as described herein may promote or permit positioning the electrically-driven module 126 in operable arrangement with fluid at the plenum 250, second flow passage 202, third flow passage 203, or combinations thereof, such as described herein.

In various embodiments, a second plenum 251 is formed between the first mating interface 171 and the second mating interface 181. The second plenum 251 may be formed radially outward of the first plenum 250. The second plenum 251 may be fluidly segregated from water at the first plenum 250, at the housing internal volume 210, or both.

It should be appreciated that structures joined at the first mating interface 171 and the second mating interface 181 each form and include a friction joining structure, friction weld structure, or spin weld structure. As such, the first mating interface 171 includes the friction weld structure at the housing end cap 150 and the housing 112, and the second mating interface includes the friction weld structure at the housing end cap 150 and the media block end cap 140.

In still some embodiments, the water filtration assembly 102 and methods for fabrication may include an ultrasonic welding process, and an associated ultrasonic weld structure. Mating interfaces and key interfaces such as described herein may provide alignments and relative thicknesses between the housing end cap 150 and the housing 112, or furthermore, the media block end cap 140, that may facilitate positioning and joining for an ultrasonic welding process.

Embodiments of the water filtration assembly 102 and method for fabrication provided herein may permit fabrication of fluidly segregated plenums, positioning of electrically-driven modules, and seals such as described herein. It should be appreciated that novel structures and methods provided herein may promote or permit construction in which direct application of welds, brazes, sealants, adhesives, or seals may be impermissible, such as lacking direct line-of-sight.

Embodiments of the water filtration assembly 102 and method for fabrication provided herein may permit more proximate positioning of water relative to a sensor, or stated differently, more proximate positioning of a sensor relative to water, such as may improve intensity of radiation provided to the water for purification, improve temperature, pressure, turbidity, or other sensing of water, or other desired interactions between the sensor and the water within the filtration assembly.

In some embodiments, such as depicted in FIGS. 5-6, a hollow conduit 160 extends through the media block internal volume 224 through the media block distal end opening 218. Referring to FIGS. 5-7, the media block end cap 140 includes end cap opening 242 extending through media block end cap 140 to permit the conduit 160 to extend through the media block distal end opening 218 in fluid communication with plenum 250. A second flow passage 202 is formed between an outer surface 264 of the conduit 160 and the filtration media block 114 at the media block internal volume 224. A third flow passage 203 is formed through the hollow conduit 160. The hollow conduit 160 may include a tube, pipe, sleeve, or wall fluidly separating the second flow passage 202 from the third flow passage 203 and including open ends through which fluid may flow from the plenum 250 to the fluid outlet opening 109. The second flow passage 202 extends in fluid communication to the plenum 250 through the end cap opening 242. The third flow passage 203 extends in fluid communication from the plenum 250 to the fluid outlet opening 109 at the housing 112 through the hollow conduit 160.

In various embodiments, the hollow conduit 160 fluidly segregates the second flow passage 202 from the fluid outlet opening 109 at the housing 112 except to permit a serial fluid flow from the second passage 202 to the plenum 250, and from the plenum 250 through the third flow passage 203 through the hollow conduit 160 to the fluid outlet opening 109. In such embodiments, the water filtration assembly 102 forms a serial flow arrangement extending from the fluid inlet opening 107 through the first flow passage 201, and through the porous structure of the filtration media block 114 to the second flow passage 202, from the second flow passage 202 to the plenum 250, and from the plenum 250 to the fluid outlet opening 109 through the third flow passage 203.

The hollow conduit 160 may include a reflective sleeve constructed of one or more materials with high reflectively with respect to the wavelength of the radiation emitted by the sensor 130. In an embodiment, the hollow conduit 160 configured as a reflective sleeve may be constructed from polytetrafluoroethylene (PTFE), aluminum, or any other material reflective to UVC radiation, such as may improve consistency and efficiency of microbial deactivation. The hollow conduit 160 may include the reflective sleeve positioned within the third flow passage 203, such as along an inner surface of the conduit 160 and configured to reflect within the conduit 160 radiation rays emitted from the electrically-driven module 126.

Referring to FIGS. 5-10, water provided proximately to the electrically-driven device 126 at the media block internal volume 224 or plenum 250 may promote or enhance operability and interaction of the electrically-driven device 126, or signals, emissions, or transmission therefrom, with the water.

In various embodiments, the electrically-driven module 126 includes the electric wire lead 127 extending through the housing end cap 150. The electrically-driven module 126 includes the sensor 130 configured to transmit, receive, or both, a signal. For instance, the sensor 130 may be configured to transmit, receive, or both, an electromagnetic signal. In some embodiments, the electrically-driven module 126 includes the sensor 130 including an electromagnetic radiation module configured as an electromagnetic radiation source positioned adjacent to the filtration media block 114. The electrically-driven module 126 and sensor 130 may include an electromagnetic radiation emitter configured to emit germicidal radiation. In various embodiments, the electrically-driven module 126 and sensor 130 include the electromagnetic radiation module configured as a UVC module including an electromagnetic radiation emitter that emits germicidal radiation via an ultraviolet-C (UVC) emitting diode. Thus, in such embodiments, the sensor 130 is configured as a UVC emitting diode. In further embodiments, the sensor 130 may include a blue light emitting diode (LED), an ultraviolet-A (UVA) emitting diode, an ultraviolet-B (UVB) emitting diode, or similar, or combinations thereof, or other appropriate configuration of light emitting diode.

In still various embodiments, the sensor 130 configured as an electromagnetic radiation module is positioned adjacent to water received from the filtration media block 114. Referring to FIGS. 5-6, the sensor 130 is positioned adjacent to (e.g., along direction of extension of axis A) a conduit inlet opening 262 of the hollow conduit 160. The conduit inlet opening 262 is positioned in the plenum 250. The sensor 130 configured as an electromagnetic radiation module is configured to emit germicidal radiation toward third flow passage 203 in the hollow conduit 160.

In still various embodiments, the sensor 130 configured as an electromagnetic radiation module is positioned within sidewall 275, such as to emit signals from the sensor 130 through the passage 277 formed at sidewall 275 and directly into the media block internal volume 224, such as depicted in FIGS. 8-10.

In some embodiments, sensor 130 is configured to measure an amount of light scatted by solids (e.g., particulates) in the water, such as total suspended solids (TSS) or total dissolved solids (TDS). The measure of amount of light scattered by solids in the water may measure turbidity (e.g., cloudiness or haziness) of the water. The electrically-driven module 126 and sensor 130 may include light-emitting sources such as described above, or additionally, photo detectors, lenses, or light-blocking and light-admitting structures. As such, embodiments of the electrically-driven module 126 and sensor 130 may include a turbidity sensor.

In still various embodiments, electrically-driven module 126 and sensor 130 may generally include a sensor configured to transmit and/or receive signals for measuring or determining an amount or concentration of solids, fluid pressure, or flowrate.

In various embodiments, the hollow conduit 160 includes the conduit inlet opening 262 positioned in the plenum 250 within approximately one inch from the electrically-driven module 126, or the sensor 130 thereof, at the housing end cap 150. In some embodiments, the conduit inlet opening 262 is positioned from at least approximately 0.10 inches from the electrically-driven module 126, or sensor 130 thereof.

In still various embodiments, the conduit inlet opening 262 is spaced from the sensor 130, such as may permit flow of water proximately to the sensor 130 before flowing through the conduit inlet opening 262 into the third flow passage 203. In some embodiments, the conduit inlet opening 262 is spaced from the sensor 130 at least approximately 0.10 inches. In still some embodiments, the conduit inlet opening 262 is spaced from the sensor 130 at least approximately 0.25 inches.

As ultraviolet (UV) radiation intensity decays substantially over distance (e.g., UV intensity decaying approximately proportionally to a square of the distance), structures provided herein facilitating flow of water proximate to a radiation emitting source may permit or enhance water purification, such as by flowing water within a distance of the sensor 130 at which germicidal radiation is more intense. Plenum 250 may furthermore permit temporal residence of water proximate to the sensor 130 for a period of time prior to flowing into the hollow conduit 160 and through the fluid outlet opening 109, such as may increase a period of time over which water is exposed to more intense germicidal radiation. Additionally, wavelengths emitted from the electrically-driven device 126 may reflect within and/or outside of the hollow conduit 160, such as may provide germicidal radiation more distal from the electrically-driven device 126, or providing one or more sensing capabilities corresponding to one or more sensor types described herein. Still further, ranges of distances such as described herein may avoid generating high-flowrate conditions or fluid stalling at, into, through, or from plenum 250. Embodiments of configuration, arrangement, and distances depicted and described herein may provide desired combinations of flowrate into and through plenum 250 and operable exposure to germicidal radiation or sensor signals from sensor 130, such as may provide improved sterilization or fluid characteristic measurement. Furthermore, configurations and ranges provided herein may provide such benefits while providing desired flowrates of treated water through the water filtration assembly 102.

In various embodiments, the electrically-driven device 126 includes a lens arranged adjacent to the sensor 130 configured as an electromagnetic radiation emitter such that the emitted radiation passes through the lens before irradiating the third flow passage 203, or additionally, the second flow passage 202 and/or plenum 250. The lens may be made of borosilicate glass or another suitable material transparent to the wavelength of the electromagnetic radiation from the emitter. In some embodiments, the lens is configured to modify the direction of the electromagnetic radiation rays. For example, in an embodiment, the lens may be configured to reduce the rays into a narrow beam and increase the radiation intensity within the plenum 250, at the third flow passage 203, at the second flow passage 202, at the media block internal volume 224, or combinations thereof.

In some embodiments, the electrically-driven device 126 includes a collimating lens arranged adjacent to the sensor 130 configured as an electromagnetic radiation emitter such that the emitted radiation light can pass through the collimating lens before irradiating the third flow passage 203, or additionally, the second flow passage 202 and/or plenum 250. For example, in an embodiment, the collimating lens is configured to provide a radiation beam with a nearly constant correction into the third flow passage 203, the second flow passage 202, the media block internal volume 224, or combinations thereof, such as may improve consistency and efficiency of microbial deactivation.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed:

1. A water filtration assembly for an appliance, comprising:
a housing comprising an inner surface adjacent to a housing internal volume, a fluid inlet opening, a fluid outlet opening, and a distal end;
a filtration media block positioned at the housing internal volume, wherein a first flow passage extends in fluid communication from the fluid inlet opening, the first flow passage at least partially formed between the inner surface of the housing and an outer surface of the filtration media block, the filtration media block comprising a media block internal volume extending from a media block distal end opening, the filtration media block comprising a porous structure permitting fluid flow from the first flow passage to the media block internal volume;
a media block end cap positioned at the media block distal end opening to receive the filtration media block, wherein the media block end cap and the housing together comprise an anti-rotation interface configured to inhibit rotation of the media block end cap relative to the housing;
a housing end cap receivable at the distal end of the housing, wherein a plenum is formed between the housing end cap and the media block end cap;
a first mating interface at which the housing end cap couples to the housing; and
an electrically-driven module positioned in operable arrangement with fluid received at the media block internal volume.

2. The water filtration assembly of claim 1, wherein the anti-rotation interface comprises a key interface comprising a key and slot at which the key is receivable.

3. The water filtration assembly of claim 1, wherein the first mating interface comprises a first wall and a first slot at which the first wall is received.

4. The water filtration assembly of claim 1, comprising:
a second mating interface at which the housing end cap couples to the media block end cap.

5. The water filtration assembly of claim 4, wherein the second mating interface comprises a second wall and a second slot at which the second wall is received.

6. The water filtration assembly of claim 4, wherein the first mating interface and the second mating interface each comprise a friction weld structure, wherein the first mating interface comprises the friction weld structure at the housing end cap and the housing, and wherein the second mating interface comprises the friction weld structure at the housing end cap and the media block end cap.

7. The water filtration assembly of claim 4, wherein the electrically-driven module comprises a sensor positioned within the media block end cap, and wherein an electric wire lead extends from the media block end cap through the housing end cap.

8. The water filtration assembly of claim 7, wherein the media block end cap and the housing end cap each comprise a lead opening through which the electric wire lead extends to the sensor positioned at the media block end cap.

9. The water filtration assembly of claim 8, wherein the media block end cap and the housing end cap each comprise the lead opening positioned through a centerline axis mutual to the media block end cap, the housing end cap, and the housing.

10. The water filtration assembly of claim 9, wherein the lead opening at the housing end cap extends from the sensor to an exterior of the housing end cap.

11. The water filtration assembly of claim 8, wherein the media block end cap comprises a neck extending into the housing end cap, wherein the lead opening is positioned at the neck.

12. The water filtration assembly of claim 11, wherein the second mating interface is positioned radially outward of the neck of the media block end cap, the second mating interface inhibiting fluid communication between the neck and the plenum.

13. The water filtration assembly of claim 4, wherein the electrically-driven module comprises a sensor positioned within the housing end cap.

14. The water filtration assembly of claim 13, wherein the sensor of the electrically-driven module is positioned adjacent to a conduit inlet opening of a hollow conduit extended into the plenum and the media block internal volume.

15. The water filtration assembly of claim 13, wherein the second mating interface is positioned radially outward of the sensor at the housing end cap.

16. The water filtration assembly of claim 1, wherein the media block end cap comprises a sidewall extending from an end cap opening into the media block internal volume, wherein the sensor of the electrically-driven device extends into a passage formed at the sidewall.

17. The water filtration assembly of claim 16, wherein the sidewall comprises a cylindrical barrier extending into the media block internal volume.

18. The water filtration assembly of claim 16, the electrically-driven device comprising a lens positioned in the passage at the sidewall, the lens arranged adjacent to the sensor configured as an electromagnetic radiation emitter such that electromagnetic radiation emitted by the electromagnetic radiation emitter passes through the lens before treating the water in the media block internal volume.

19. The water filtration assembly of claim 1, wherein the sensor of the electrically-driven module comprises an electromagnetic radiation module, the electromagnetic radiation module comprising an electromagnetic radiation emitter that emits germicidal radiation via at least one of an ultraviolet-C (UVC) emitting diode, a blue light emitting diode (LED), an ultraviolet-A (UVA) emitting diode, or an ultraviolet-B (UVB) emitting diode.

20. A water filtration assembly for an appliance, the water filtration assembly comprising:
a first mating interface at which a housing end cap couples to a housing, wherein a plenum is formed between the housing end cap and a media block end cap at which a filtration media block is received and positioned in the housing, the media block end cap and the housing together comprising an anti-rotation interface configured to inhibit rotation of the media block end cap relative to the housing; and
an electrically-driven module positioned in operable arrangement with fluid received at a media block internal volume downstream of a porous structure of the filtration media block and a first flow passage between an inner surface of the housing and an outer surface of the filtration media block.
